(19) United States
(12) Patent Application Publication
(10) Pub. No.: US 2022/0298420 A1
(43) Pub. Date: Sep. 22, 2022

(54) MULTIFUNCTIONAL LIQUID CRYSTALLINE PHOTOREACTIVE POLYMERS FOR POLARIZATION HOLOGRAPHY

(71) Applicant: Facebook Technologies, LLC, Menlo Park, CA (US)

(72) Inventors: Ryan LI, Woodinville, WA (US); Lu LU, Kirkland, WA (US); Junren WANG, Kirkland, WA (US); Mengfei WANG, Kirkland, WA (US)

(21) Appl. No.: 17/207,404

(22) Filed: Mar. 19, 2021

(51) Int. Cl. C09K 19/38; C08F 293/00; G03H 1/02

(52) U.S. Cl. CPC C09K 19/3842; C08F 293/00; G03H 1/02; C08F 2810/20; C09K 2019/0448

(57) ABSTRACT

A multifunctional liquid crystalline photoreactive polymer in which at least some of the polymer side-chains have an ultraviolet photoreactive moiety and at least some of the polymer side-chains have a calamitic mesogenic moiety are provided. At least some of the polymer side-chains have a photo-curable moiety a thermal-curable moiety. In some embodiments, the polymer is in the form of a co-polymer. In some embodiments, the polymer is in the form of a ter-polymer. The polymer is used in applications that require stable birefringement films. Such films are produced from the polymer by subjecting the polymer to ultra-violet light to cause side-chain cross-linking thereby inducing anisotropy. The anisotropy is then amplified by exposing the polymer to an elevated temperature.

### FIELD

Described herein are multifunctional liquid crystalline photoreactive polymers for polarization holography.

### BACKGROUND

Maintaining polarization conversion is important for optical applications in the augmented reality/virtual reality (AR/VR) field. Such applications include using polarization volume holography (PVH) as pupil duplication optical combiners to relay the imaging from the projector to a user's eyes.

Conventionally, PVH have been made by a reactive mesogen (RMs) (also known as Bragg-regime photo-aligned liquid crystalline polymer network) with a photo-alignment material (PAM), for instance a photo-alignment layer (PAL). Referring to FIG. 1, the polarization pattern is first created in PAM 104, e.g. overlayed on a substrate 102, via polarization holography through two beam interference or direct writing. Then the RM 106 is deposited or coated on top of the PAM. The RM copies the alignment information from the PAM via intermolecular interactions on the interface. In other words, the RM becomes aligned according to the anisotropic surface pattern of the PAM. The RM is then fixed upon flood ultra-violet light exposure. Success has been demonstrated by using RMs and PAMs to make reflective type PVH (R-PVH) devices. Such devices exhibit great efficiency, and polarization conversion. See, for example, Kobashi et al., 2016, “Planar optics with patterned chiral liquid crystals,” Nature Photonics 10. 10.1038/nphoton.2016.66.

Similar materials and processes have also been used for making polarization gratings, also referred to a pancharatnam berry phase (PBP) devices. See, Cheng et al., 2015, “Analysis of a dual-twist Pancharatnam phase device with ultrahigh-efficiency large-angle optical beam steering,” Appl. Opt. 54, 10035-10043. Such devices have great efficiency but poor polarization conversion at large diffraction angles in transmissive type polarization volume holography (T-PVH). See, Xiang et al., 2018, “Wide-field-of-view nanoscale Bragg liquid crystal polarization gratings,” Proc. SPIE 10555, Emerging Liquid Crystal Technologies XIII, 1055508 doi: 10.1117/12.2303994. In such devices, RM comprises a periodic director profile with in-plane optic axis that varies linearly with position. The orientation angle of the nematic director (and optic axis) in each layer follows:

Φ(x,z)=πx/Λₓ+ϕz/d,

where Λₓ and d are the surface grating period determined by the holography exposure and thickness respectively as illustrated in FIG. 1. The angle ϕ represents the twist angle in the grating induced by the chiral dopants and the twist rate ϕ/d can be controlled by varying chiral concentrations. Similar to conventional Bragg gratings formed when the period is near or below the operational wavelength, Bragg PGs diffract light into large deflection angles with high diffraction efficiency and are generally sensitive to the angle of incidence. For VHGs, the center of the angular response can be adjusted by varying the slant angle during the grating fabrication. For Bragg PGs, this is done indirectly by adjusting the twist rate which relates to the slant angle by θ_{G}=tan⁻¹(ϕΛₓ=dπ).

A slanted structure, such as illustrated in FIG. 2, is used to address the polarization conversion issue, in which the LC rotation plane 204 is perpendicular to the Bragg planes 202. The kind of structure illustrated in FIG. 2 allows for the fabrication of highly efficient T-PVH devices (e.g., gratings, lenses, or free-form optics) while maintaining the correct polarization conversion.

However, conventional RMs and PAMs and processes for using them are not satisfactory for the manufacture of the slanted structure illustrated in FIG. 2. What are needed are materials that can directly respond to the polarization of the recording beam. At the same time, such materials need to form enough birefringence to display optical properties. To date, conventional materials, termed bulk photoalignment materials (BPAM), have been developed. See, for example, H. Kobashi et al., 2016, “Planar optics with patterned chiral liquid crystals,” Nature Photon 10, pp. 389-392; Cheng et al., 2015, “Analysis of a dual-twist Pancharatnam phase device with ultrahigh-efficiency large-angle optical beam steering,” Appl. Opt. 54, pp. 10035-10043; and M. Xiang et al., 2018, “Wide-field-of-view nanoscale Bragg liquid crystal polarization gratings,” Proc. of SPIE 10555, p. 1055508.

The bulk photoalignment material comprises photoreactive groups coupled with mesogens. As such, the bulk photoalignment material exhibits liquid crystal properties, because of the mesogens, but can be anisotropically polarized because of the photoreactive groups. For this reason, such materials can be referred to as liquid crystalline photoreactive polymers. As illustrated in FIG. 3, photoinduced optical and physical anisotropies can be generated in the bulk photoalignment material (liquid crystalline photoreactive polymer) by light exposure because the photoreaction changes the inherent refractive index of the molecules. Irradiating with linearly polarized (LP) light causes the photoreactive groups parallel to the polarization (E) of LP light (y axis) to preferentially photoreact. This axis-selective photoreaction leads to optical anisotropy (birefringence) between the y axis and xz plane if the photoreaction changes the inherent refractive indices of the bulk photoalignment material. This is further illustrated in FIG. 4. Exposure of the bulk photoalignment material 402 to linearly polarized UV (LPUV) 404 induces a small anisotropy that is amplified in the bulk 406 upon annealing in liquid crystal phase due to the self-assembly property of the bulk photoalignment material.

The photoreactive groups used in such bulk photoalignment material can be azobenzene (see, e.g., Zhao and Ikeda, 2009, Smart Light-Responsive Materials: azobenzene-containing polymers and liquid crystals, John Wiley & Sons, Hoboken, USA), cinnamate (see, e.g., Ichimura, 2000, “Photoalignment of Liquid-crystal Systems,” Chem. Rev. 100, 1847-1873), coumarin (see, e.g., Chen et al., 2006, “New Insight into Photoalignment of Liquid Crystals on Coumarin-Containing Polymer Films,” Macromolecules 39, pp. 3817-3823), stilbene (see, e.g., Sakhno et al., 2018, “Bragg polarization gratings used as switchable elements in AR/VR holographic displays,” Proc. SPIE 10676), or benzoate (see, e.g., Kawatsuki et al., 2012, “Photoinduced Reorientation of a Liquid Crystalline Polymer with Phenyl Benzoate Mesogenic Side Groups on the Basis of an Axis-Selective Photo-Fries Rearrangement,” Macromolecules 45, pp. 8547-8554), that undergoes cis-trans isomerization, [2+2] cycloaddition, or photo-Fries rearrangement.

One process for using liquid crystalline photoreactive polymers (LCPP) includes photo-induced anisotropy, followed by annealing (thermal enhancement or amplification) to maximize the anisotropy (birefringence). To achieve this, the LCPP is a linear polymer with or without optimal crosslinking so that the thermal annealing in the liquid crystal phase can drive the cooperative mesogen self-assembly above a glass transition temperature (Tg) or melting point (Tm) to be aligned by the photoinduced anisotropy seed. The result can be described as TAPA (thermally amplified photoinduced anisotropy) process, as illustrated in FIGS. 5 and 6. In these figures, upon irradiation with linearly polarized UV light, the photocycloaddition of cinnamate moieties, which serve as the photoreactive group, take place in an angle selective way forming parallel to the E-field vector dimeric cyclobutane photoproducts. In this way, a weak anisotropy is generated in the glassy films at room temperature by the conversion of the cinnamic ester groups under the formation of dimeric photoproducts. The second processing step is annealing of the film above the glass transition temperature, Tg, causing a bulk-alignment of the whole LC polymer film due to the alignment of all mesogenic side groups parallel to the photoproducts. The self-organization in the mesophase results in a significant enhancement of birefringence. Moreover, the photocycloaddition of the cinnamate ester group leads by the crosslinking of the film to high, thermal stability and high solvent resistivity. If required, the stability of non-patterned films or polarization gratings can be improved by subsequent non-polarized flood UV exposure. See, Sakhno, 2018, “Bragg polarization gratings used as switchable elements in AR/VR holographic displays,” Proc. SPIE 10676, Digital Optics for Immersive Displays, 106760F (21 May 2018); doi: 10.1117/12.2309788.

Existing liquid crystalline photoreactive polymer materials have drawbacks. Conventional crystalline photoreactive polymer materials result in structures that have a birefringence An in the range of 0.1-0.4. For instance, the liquid crystalline photoreactive polymer materials M1 and M3 of FIG. 7A have a birefringence at 633 nm of 0.24 and 0.15 respectively. See, Kawatsuki, 2011, “Photoalignment and Photoinduced Molecular Reorientation of Photosensitive Materials,” Chem. Lett., 40, pp. 548-554. What is needed in the art is lower birefringence (Δn<0.1) for low rainbow and better see-through polarization volume holography. Optical elements with Δn<0.1 would enable better see-through image quality with polarization optical elements, for optical applications in AR/VR systems, such as using polarization volume holography—infrared elements for eye-tracking purposes. Optical elements with Δn<0.1 would also enable a new design space of color-selective and angular selective polarization optical elements, for optical applications in augmented reality/virtual reality systems, such as polarization volume holography—visible waveguide combiners.

Conventional crystalline photoreactive polymer materials are also unstable at elevated temperatures due to their thermal plastic nature. Consistency is needed within a wider temperature range. For instance, referring to the terpoylmer TP2 in FIG. 8, the polymer enters the nematic phase at 57° C. and the isotropic phase at 98° C. and therefore has a very limited application range of above 57° C. to below 98° C. This is because, while a temperature of at least 57° C. induces TP2 into the liquid crystal state, the liquid crystal state disappears at temperatures above 98° C. Further, the polymer illustrated at the top of FIG. 9 enters the nematic phase at 135° C. and the isotropic phase at 187° C. and therefore has a very limited application range—below 187° C. For instance, the An of the polymer goes from 0.19 to zero within five minutes at 200° C.

Conventional crystalline photoreactive polymer materials also exhibit ultraviolet light instability. That is, their birefringence changes as a function of ultraviolet light exposure, resulting in performance deterioration upon extended exposure to ultraviolet light. For example, the cinnamate and the stilbene groups in the conventional crystalline photoreactive polymer materials illustrated in FIG. 8 exhibit a simultaneous absorbance decrease at their characteristic absorption bands (392 nm and 460 nm) upon irradiation at 325 nm indicating degradation in the present of UV light. See, Rosenhauer, 2003, “Light-induced anisotropy of stilbene containing LC polymers and its thermal development by self-organization,” Proceedings of SPIE Vol. 5213 Liquid Crystals VII, edited by Iam-Choon Khoo. Moreover, upon exposure to ultraviolet light, the polymer illustrated at the top of FIG. 9 undergoes [2+2] cycloaddition (bottom of FIG. 9) thereby decreasing the Δn from 0.19 to approximately 0.1 upon exposure to ultraviolet light.

Further still, many conventional crystalline photoreactive polymer materials also crystallize into a hazy thin film, which degrades performance. What is desired is an optically clear film. Additionally, conventional crystalline photoreactive polymer materials also tend to have unsatisfactory adhesion properties. Adhesion to a substrate is needed to be a robust device without delamination.

Accordingly, given the above background, improved liquid crystalline photoreactive polymer materials are needed in the art.

### SUMMARY

The present disclosure addresses the shortcomings in conventional liquid crystalline photoreactive polymers by providing multifunctional liquid crystalline photoreactive polymers in which the birefringence can be customized from below 0.1 to greater than 0.4 in accordance with device design requirements. The multifunctional liquid crystalline photoreactive polymers exhibit improved ultraviolet light stability, improved thermal stability, improved film clarity, and improved adhesion relative to conventional liquid crystalline photoreactive polymers.

One aspect of the present disclosure provides a polymer that has, or is derived by side-chain crosslinking from, the structure:

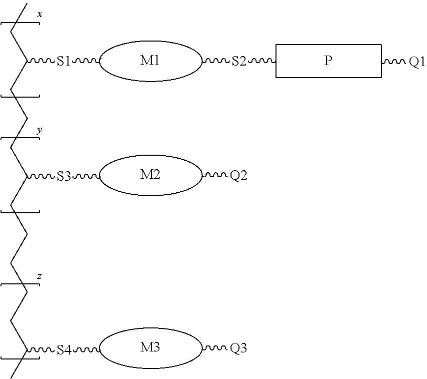

where P is an ultraviolet photoreactive moiety, M1 is a calamitic mesogenic or non-mesogenic moiety, M2 is a calamitic mesogenic moiety, M3 is a calamitic mesogenic or non-mesogenic moiety, at least two of Q1, Q2, and Q3 are each photo-curable moiety or at least two of Q1, Q2, and Q3 are each a thermal-curable moiety, and S1, S2, S3, and S4 are spacers. In some embodiments x+y=1 and z is equal to zero. In other embodiments x+y+z=1.

### BRIEF DESCRIPTION OF THE DRAWINGS

The foregoing summary, as well as the following detailed description of the present disclosure, will be better understood when read in conjunction with the appended drawings.

FIG. 1 illustrates generic steps for forming a polarization pattern with a photo-alignment material optionally overlayed on a substrate and copying this polarization pattern into a reactive mesogen layer overlayed on the photo-alignment material in accordance with the prior art.

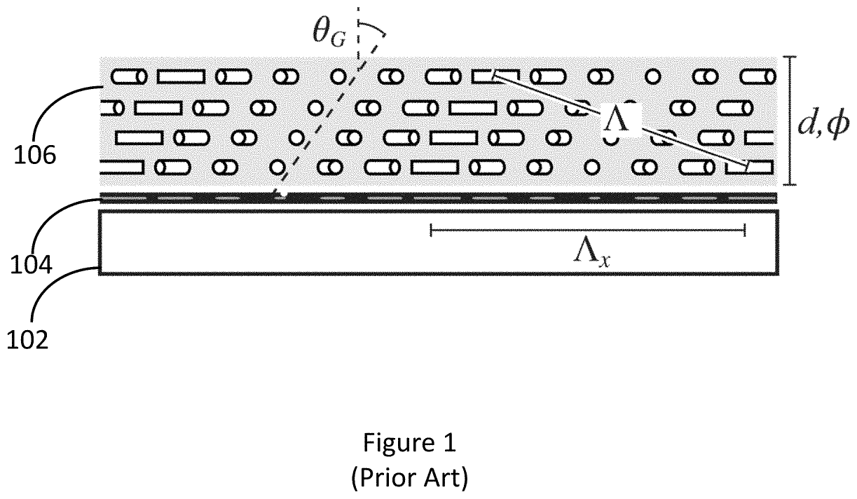

FIG. 2 illustrates a slanted polarization volume holography device in which the Bragg planes are slanted with respect to the substrate in accordance with the prior art.

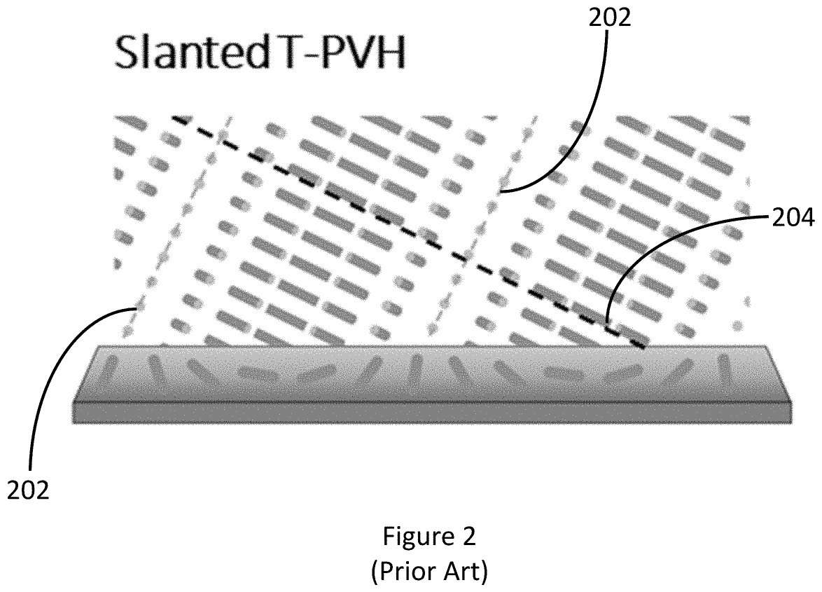

FIG. 3 illustrates how irradiating with linearly polarized (LP) light causes photoreactive groups within a bulk photoalignment material that are parallel to the polarization (E) of LP light (y axis) to preferentially photoreact, leading to optical anisotropy (birefringence) between the y axis and xz plane in accordance with the prior art.

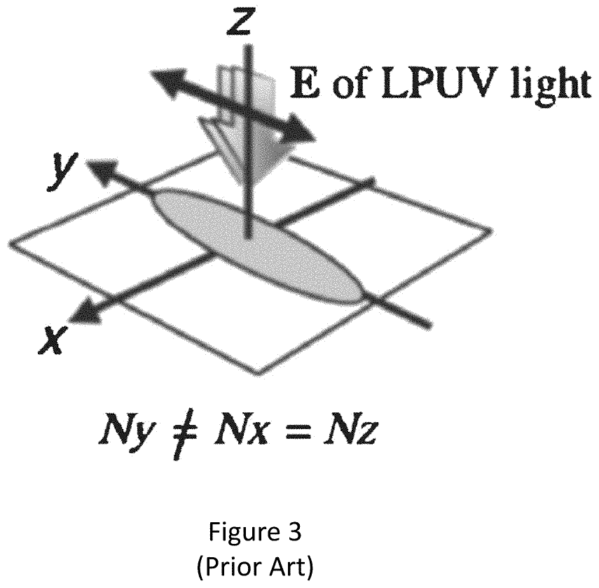

FIG. 4 illustrates how irradiating with linearly polarized (LP) light causes photoreactive groups within a bulk photoalignment material that are parallel to the polarization (E) of LP light (y axis) to preferentially photoreact leading to optical anisotropy (birefringence), and further shows how this anisotropy is amplified upon annealing due to the self-assembly property of the bulk photoalignment material in accordance with the prior art.

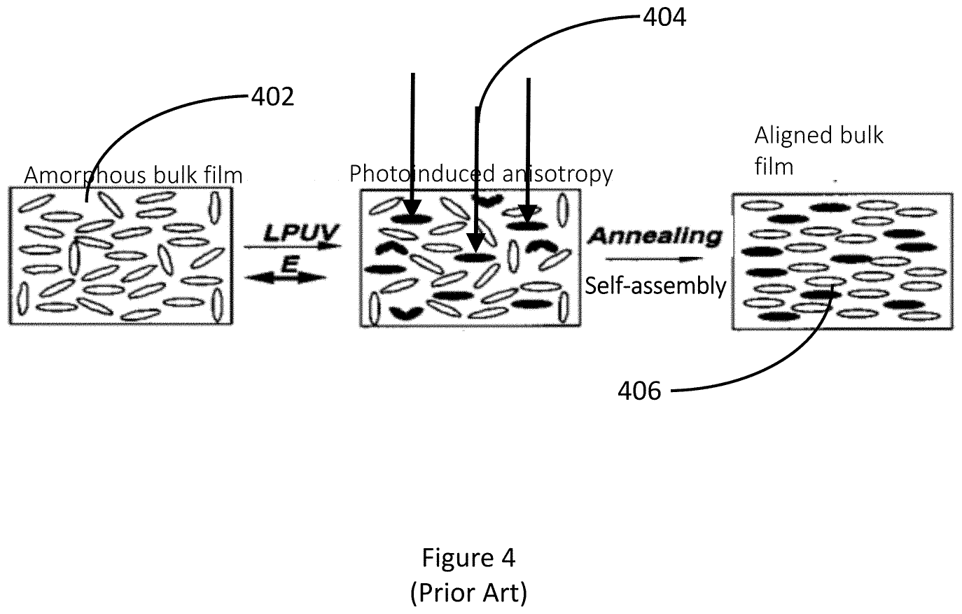

FIG. 5 illustrates how conventional liquid crystalline photoreactive polymers incur photo-induced anisotropy through the photocycloaddition of cinnamate moieties within the conventional liquid crystalline photoreactive polymers upon exposure to linearly polarized UV light in accordance with the prior art.

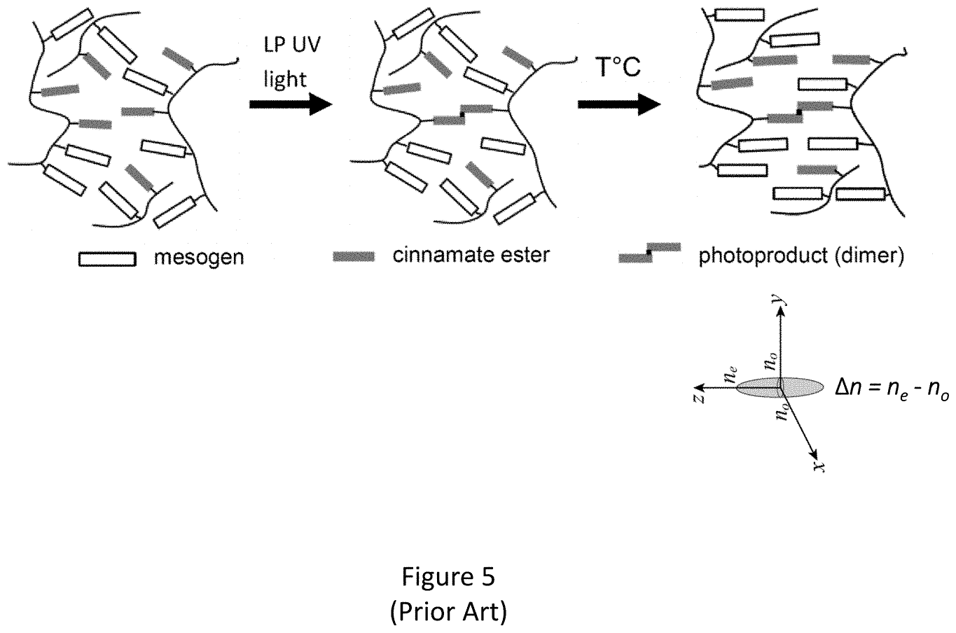

FIG. 6 also illustrates how conventional liquid crystalline photoreactive polymers incur photo-induced anisotropy through the photocycloaddition of cinnamate moieties within the conventional liquid crystalline photoreactive polymers upon exposure to linearly polarized UV light in accordance with the prior art.

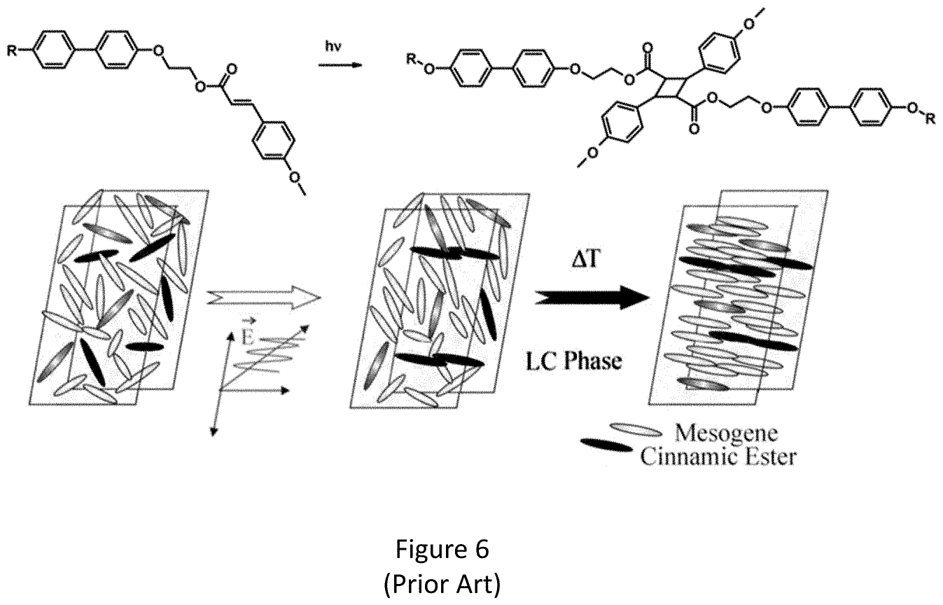

FIG. 7 illustrates the chemical structure of two conventional liquid crystalline photoreactive polymers in accordance with the prior art.

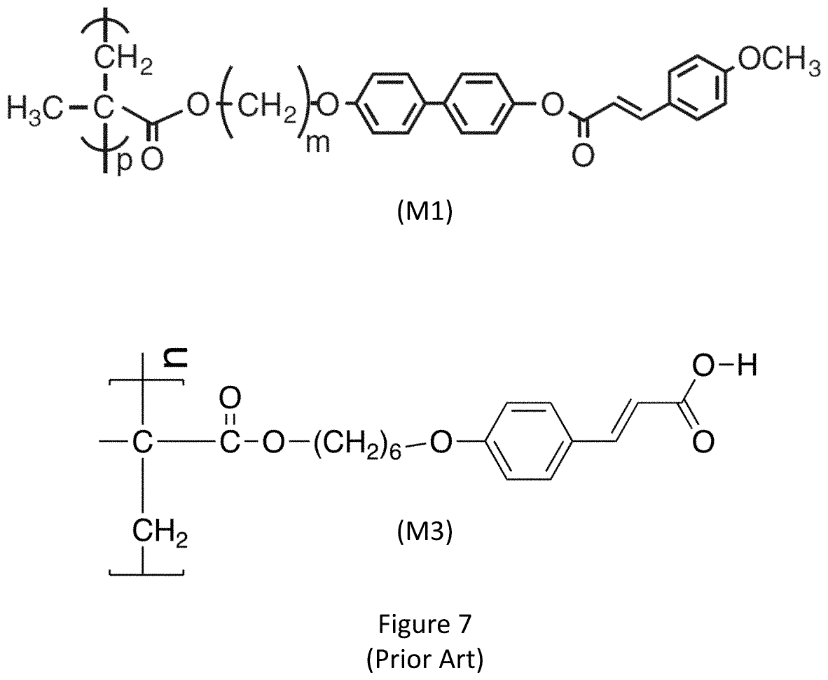

FIG. 8 illustrates the chemical structure of related conventional liquid crystalline photoreactive polymers and their sensitivity to UV light an indicated by a decrease in their absorption at two characteristic wavelengths upon exposure to UV light in accordance with the prior art.

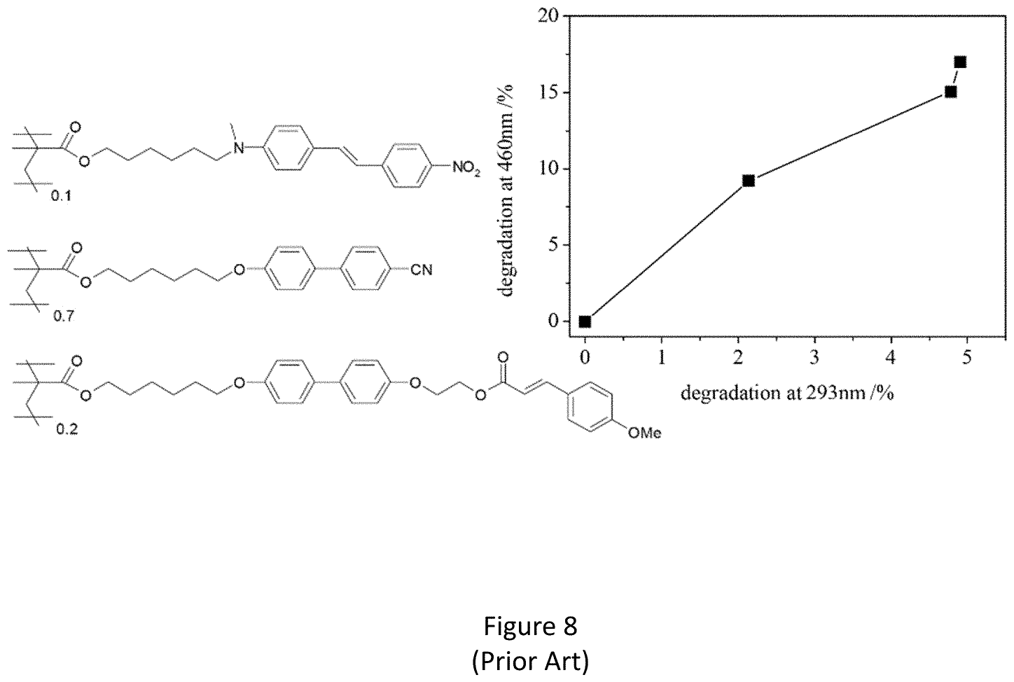

FIG. 9 illustrates the [2+2] cycloaddition of a conventional mesogenic polymer in accordance with the prior art.

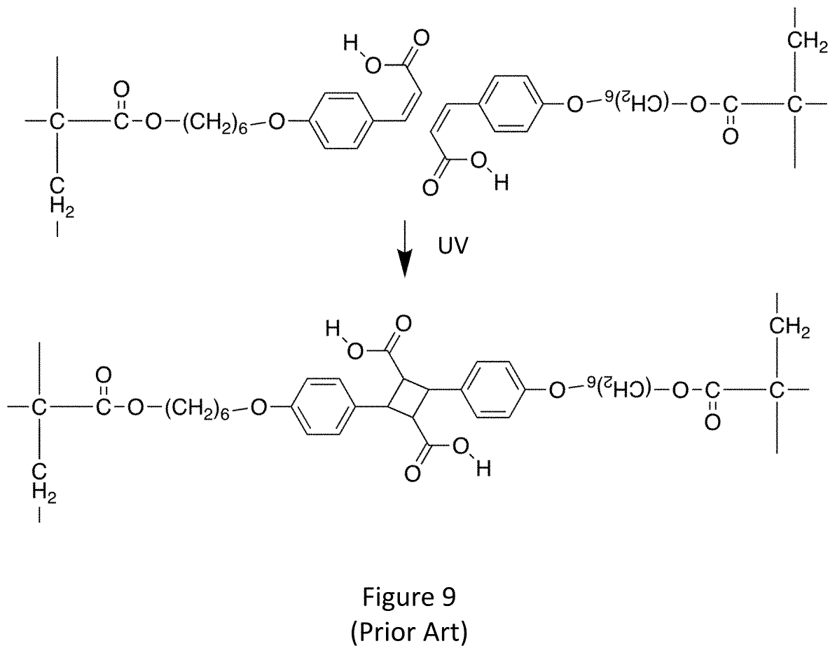

FIG. 10 illustrates how the polymers of the present disclosure set by cross-linking after thermally amplified photoinduced anisotropy in accordance with the present disclosure.

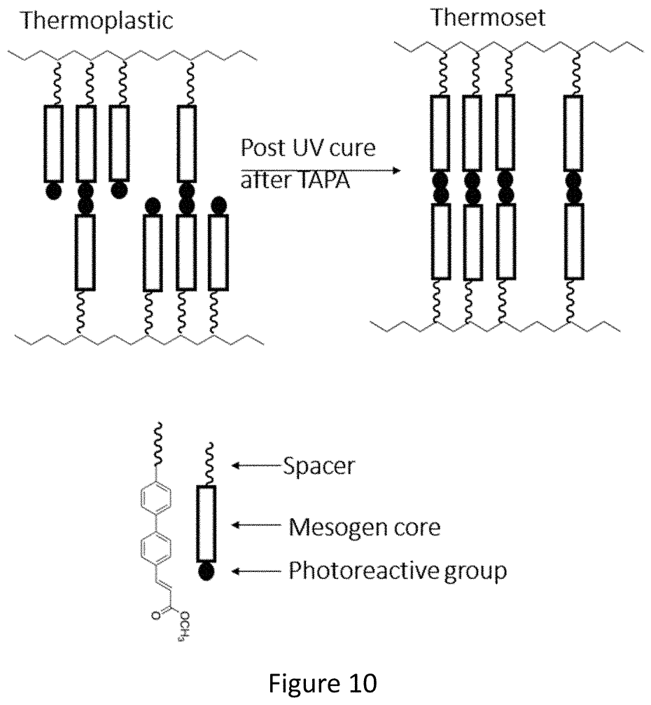

FIG. 11 illustrates an example of polymers in accordance with the present disclosure cross-link.

FIG. 12 illustrates the various states of mesogenic compounds in accordance with the prior art.

FIG. 13 illustrates example cationic polymerizable groups that can be used in the polymers of the present disclosure.

### DETAILED DESCRIPTION

### I. Introduction

The present disclosure is directed to multifunctional liquid crystalline photoreactive polymers in which at least some of the polymer side-chains have an ultraviolet photoreactive moiety and at least some of the polymer side-chains have a calamitic mesogenic moiety. At least some of the polymer side-chains have a photo-curable moiety a thermal-curable moiety. In some embodiments, the polymer is in the form of a co-polymer. In some embodiments, the polymer is in the form of a ter-polymer. The polymer is used in applications that require stable birefringement films. Such films are produced from the polymer by subjecting the polymer to ultra-violet light to cause side-chain cross-linking thereby inducing anisotropy. The anisotropy is then amplified by exposing the polymer to an elevated temperature.

### II. Definitions

Unless defined otherwise, all technical and scientific terms used herein have the same meaning as is commonly understood by one of skill in the art to which this disclosure belongs. All patents and publications referred to herein are incorporated by reference in their entireties.

When ranges are used herein to describe, for example, physical or chemical properties such as molecular weight or chemical formulae, all combinations and subcombinations of ranges and specific embodiments therein are intended to be included. Use of the term “about” when referring to a number or a numerical range means that the number or numerical range referred to is an approximation within experimental variability (or within statistical experimental error), and thus the number or numerical range may vary. The variation is typically from 0% to 15%, or from 0% to 10%, or from 0% to 5% of the stated number or numerical range. The term “including” (and related terms such as “comprise” or “comprises” or “having” or “including”) includes those embodiments such as, for example, an embodiment of any composition of matter, method or process that “consist of” or “consist essentially of” the described features.

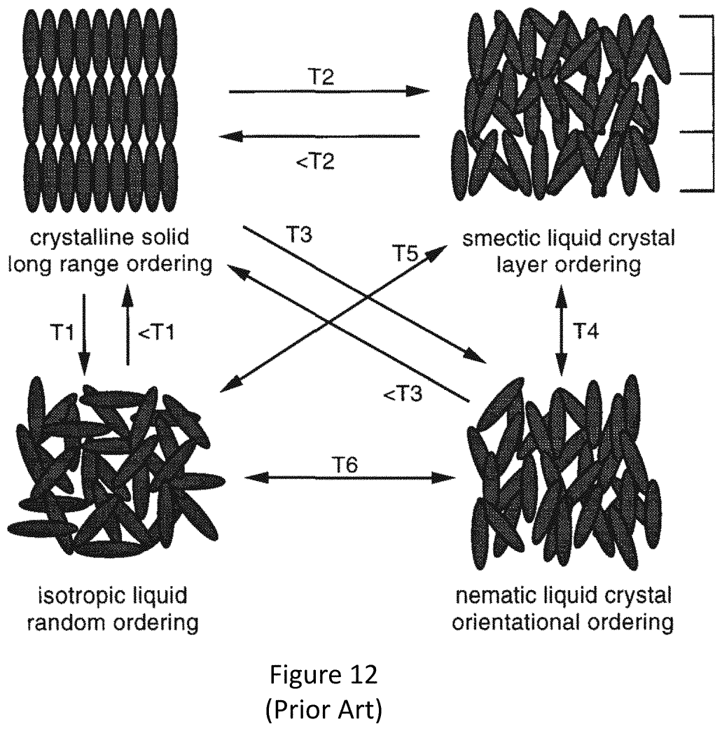

As used herein, the term “calamitic mesogenic moiety” refers to a rod-like liquid material that is capable of being in a liquid crystalline phase. In some embodiments, a calamitic mesogenic moiety refers to a rod-like liquid material that is capable of being in a liquid crystalline nematic phase. In some embodiments, a calamitic mesogenic moiety refers to a rod-like liquid material that is capable of being in a liquid crystalline sematic phase. Referring to FIG. 12, mesogenic (e.g., mesophase-producing) compounds generally consist of long, narrow, lath-like and fairly rigid molecules. In the crystal state (C), the molecules are held together by strong intermolecular forces of attraction which, due to the rod-like structure, are anisotropic. The smectic phase arises if the lateral intermolecular forces of attraction are stronger than the terminal forces and so, on heating, the terminal forces break down first, in-plane translational order is lost and this results in a lamellar arrangement of molecules in which the layers are not perfectly defined (T2). Due to possible correlations within the layers and between the layers, there are five true smectic modifications and a further six quasi-smectic disordered crystal mesophases. T3 represents the loss of both in-plane and out-of-plane translational order to leave a statistically parallel arrangement of molecules (orientational order) in the nematic phase. When the smectic phase is heated, either out-of-plane translational ordering is lost (T4), which produces the nematic phase, or additionally orientational ordering is lost (T5), which gives the isotropic liquid (I). T6 depicts the loss of orientational ordering of the nematic phase to give the isotropic liquid. Many compounds do exhibit two or three different types of liquid crystalline phases.

As used herein, the terms “volume Bragg grating,” “volume holographic grating,” “holographic grating,” and “hologram,” are interchangeably used to refer to a recorded interference pattern formed when a signal beam and a reference beam interfere with each other. In some embodiments, and in cases where digital data is recorded, the signal beam is encoded with a spatial light modulator.

As used herein, the term “holographic recording” refers to a holographic grating after it is recorded in the holographic recording medium.

As used herein, the term “holographic recording medium” refers to an article that is capable of recording and storing, in three dimensions, one or more holographic gratings. In some embodiments, the term refers to an article that is capable of recording and storing, in three dimensions, one or more holographic gratings as one or more pages as patterns of varying refractive index imprinted into an article.

As used herein, the term “recording light” refers to a light source used to record into a holographic medium. The spatial light intensity pattern of the recording light is what is recorded. Thus, if the recording light is a simple noncoherent beam of light, then a waveguide may be created, or if it is two interfering laser beams, then interference patterns will be recorded.

Unless otherwise stated, the chemical structures depicted herein are intended to include compounds which differ only in the presence of one or more isotopically enriched atoms. For example, compounds where one or more hydrogen atoms is replaced by deuterium or tritium, or where one or more carbon atoms is replaced by ¹³C- or ¹⁴C-enriched carbons, are within the scope of this disclosure.

“Alkyl” refers to a straight (n-alkyl) or branched (branched chain alkyl) hydrocarbon chain radical consisting solely of carbon and hydrogen atoms, containing no unsaturation, having from one to ten carbon atoms (e.g., (C₁-C₁₀)alkyl or C₁₋₁₀ alkyl). Whenever it appears herein, a numerical range such as “1 to 10” refers to each integer in the given range—e.g., “1 to 10 carbon atoms” means that the alkyl group may consist of 1 carbon atom, 2 carbon atoms, 3 carbon atoms, etc., up to and including 10 carbon atoms, although the definition is also intended to cover the occurrence of the term “alkyl” where no numerical range is specifically designated. Typical alkyl groups include, but are in no way limited to, methyl, ethyl, propyl, isopropyl, n-butyl, isobutyl, sec-butyl isobutyl, tertiary butyl, pentyl, isopentyl, neopentyl, hexyl, septyl, octyl, nonyl and decyl. The alkyl moiety may be attached to the rest of the molecule by a single bond, such as for example, methyl (Me), ethyl (Et), n-propyl (Pr), 1-methylethyl (isopropyl), n-butyl, n-pentyl, 1,1-dimethylethyl (t-butyl) and 3-methylhexyl. Unless stated otherwise specifically in the specification, an alkyl group is optionally substituted by one or more of substituents which are independently heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂ where each R^{a} is independently hydrogen, fluoroalkyl, carbocyclyl, carbocyclylalkyl, aryl, aralkyl, heterocycloalkyl, heterocycloalkylalkyl, heteroaryl or heteroarylalkyl.

“Alkylaryl” refers to an -(alkyl)aryl radical where aryl and alkyl are as disclosed herein and which are optionally substituted by one or more of the substituents described as suitable substituents for aryl and alkyl respectively.

“Alkylhetaryl” refers to an -(alkyl)hetaryl radical where hetaryl and alkyl are as disclosed herein and which are optionally substituted by one or more of the substituents described as suitable substituents for aryl and alkyl respectively.

“Alkylheterocycloalkyl” refers to an -(alkyl) heterocyclyl radical where alkyl and heterocycloalkyl are as disclosed herein and which are optionally substituted by one or more of the substituents described as suitable substituents for heterocycloalkyl and alkyl respectively.

An “alkene” moiety refers to a group consisting of at least two carbon atoms and at least one carbon-carbon double bond, and an “alkyne” moiety refers to a group consisting of at least two carbon atoms and at least one carbon-carbon triple bond. The alkyl moiety, whether saturated or unsaturated, may be branched, straight chain, or cyclic.

“Alkenyl” refers to a straight or branched hydrocarbon chain radical group consisting solely of carbon and hydrogen atoms, containing at least one double bond, and having from two to ten carbon atoms (e.g., (C₂₋₁₀)alkenyl or C₂₋₁₀ alkenyl). Whenever it appears herein, a numerical range such as “2 to 10” refers to each integer in the given range—e.g., “2 to 10 carbon atoms” means that the alkenyl group may consist of 2 carbon atoms, 3 carbon atoms, etc., up to and including 10 carbon atoms. The alkenyl moiety may be attached to the rest of the molecule by a single bond, such as for example, ethenyl (e.g., vinyl), prop-1-enyl (e.g., allyl), but-1-enyl, pent-l-enyl and penta-1,4-dienyl. Unless stated otherwise specifically in the specification, an alkenyl group is optionally substituted by one or more substituents which are independently alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Alkenyl-cycloalkyl” refers to an -(alkenyl)cycloalkyl radical where alkenyl and cycloalkyl are as disclosed herein and which are optionally substituted by one or more of the substituents described as suitable substituents for alkenyl and cycloalkyl respectively.

“Alkynyl” refers to a straight or branched hydrocarbon chain radical group consisting solely of carbon and hydrogen atoms, containing at least one triple bond, having from two to ten carbon atoms (e.g., (C₂₋₁₀)alkynyl or C₂₋₁₀ alkynyl). Whenever it appears herein, a numerical range such as “2 to 10” refers to each integer in the given range—e.g., “2 to 10 carbon atoms” means that the alkynyl group may consist of 2 carbon atoms, 3 carbon atoms, etc., up to and including 10 carbon atoms. The alkynyl may be attached to the rest of the molecule by a single bond, for example, ethynyl, propynyl, butynyl, pentynyl and hexynyl. Unless stated otherwise specifically in the specification, an alkynyl group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Alkynyl-cycloalkyl” refers to an -(alkynyl)cycloalkyl radical where alkynyl and cycloalkyl are as disclosed herein and which are optionally substituted by one or more of the substituents described as suitable substituents for alkynyl and cycloalkyl respectively.

“Carboxaldehyde” refers to a —(C═O)H radical.

“Carboxyl” refers to a —(C═O)OH radical.

“Cyano” refers to a —CN radical.

“Cycloalkyl” refers to a monocyclic or polycyclic radical that contains only carbon and hydrogen, and may be saturated, or partially unsaturated. Cycloalkyl groups include groups having from 3 to 10 ring atoms (e.g. (C₃₋₁₀)cycloalkyl or C₃₋₁₀ cycloalkyl). Whenever it appears herein, a numerical range such as “3 to 10” refers to each integer in the given range—e.g., “3 to 10 carbon atoms” means that the cycloalkyl group may consist of 3 carbon atoms, etc., up to and including 10 carbon atoms. Illustrative examples of cycloalkyl groups include, but are not limited to the following moieties: cyclopropyl, cyclobutyl, cyclopentyl, cyclopentenyl, cyclohexyl, cyclohexenyl, cycloheptyl, cyclooctyl, cyclononyl, cyclodecyl, norbornyl, and the like. Unless stated otherwise specifically in the specification, a cycloalkyl group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Cycloalkyl-alkenyl” refers to a -(cycloalkyl)alkenyl radical where cycloalkyl and alkenyl are as disclosed herein and which are optionally substituted by one or more of the substituents described as suitable substituents for cycloalkyl and alkenyl, respectively.

“Cycloalkyl-heterocycloalkyl” refers to a -(cycloalkyl)heterocycloalkyl radical where cycloalkyl and heterocycloalkyl are as disclosed herein and which are optionally substituted by one or more of the substituents described as suitable substituents for cycloalkyl and heterocycloalkyl, respectively.

“Cycloalkyl-heteroaryl” refers to a -(cycloalkyl)heteroaryl radical where cycloalkyl and heteroaryl are as disclosed herein and which are optionally substituted by one or more of the substituents described as suitable substituents for cycloalkyl and heteroaryl, respectively.

The term “alkoxy” refers to the group -0-alkyl, including from 1 to 8 carbon atoms of a straight, branched, cyclic configuration and combinations thereof attached to the parent structure through an oxygen. Examples include, but are not limited to, methoxy, ethoxy, propoxy, isopropoxy, cyclopropyloxy and cyclohexyloxy. “Lower alkoxy” refers to alkoxy groups containing one to six carbons.

The term “substituted alkoxy” refers to alkoxy where the alkyl constituent is substituted (e.g., —O-(substituted alkyl)). Unless stated otherwise specifically in the specification, the alkyl moiety of an alkoxy group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

The term “alkoxycarbonyl” refers to a group of the formula (alkoxy)(C═O)— attached through the carbonyl carbon where the alkoxy group has the indicated number of carbon atoms. Thus a (C₁₋₆)alkoxycarbonyl group is an alkoxy group having from 1 to 6 carbon atoms attached through its oxygen to a carbonyl linker. “Lower alkoxycarbonyl” refers to an alkoxycarbonyl group where the alkoxy group is a lower alkoxy group.

The term “substituted alkoxycarbonyl” refers to the group (substituted alkyl)-O—C(O)— where the group is attached to the parent structure through the carbonyl functionality. Unless stated otherwise specifically in the specification, the alkyl moiety of an alkoxycarbonyl group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, —OR^{a}, —SR^{a}, ——OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{b} (where t is 1 or 2), or PO₃(R^{a})₂,where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Acyl” refers to the groups (alkyl)-C(O)—, (aryl)-C(O)—, (heteroaryl)-C(O)—, (heteroalkyl)-C(O)— and (heterocycloalkyl)-C(O)—, where the group is attached to the parent structure through the carbonyl functionality. If the R radical is heteroaryl or heterocycloalkyl, the hetero ring or chain atoms contribute to the total number of chain or ring atoms. Unless stated otherwise specifically in the specification, the alkyl, aryl or heteroaryl moiety of the acyl group is optionally substituted by one or more substituents which are independently alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{b} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Acyloxy” refers to a R(C═O)O— radical where R is alkyl, aryl, heteroaryl, heteroalkyl or heterocycloalkyl, which are as described herein. If the R radical is heteroaryl or heterocycloalkyl, the hetero ring or chain atoms contribute to the total number of chain or ring atoms. Unless stated otherwise specifically in the specification, the R of an acyloxy group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Amino” or “amine” refers to a —N(R^{a})₂ radical group, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl, unless stated otherwise specifically in the specification. When a —N(R^{a})₂ group has two R^{a} substituents other than hydrogen, they can be combined with the nitrogen atom to form a 4-, 5-, 6- or 7-membered ring. For example, —N(R^{a})₂ is intended to include, but is not limited to, 1-pyrrolidinyl and 4-morpholinyl. Unless stated otherwise specifically in the specification, an amino group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

The term “substituted amino” also refers to N-oxides of the groups —NHR^{d}, and NR^{d}R^{d} each as described above. N-oxides can be prepared by treatment of the corresponding amino group with, for example, hydrogen peroxide or m-chloroperoxybenzoic acid.

“Amide” or “amido” refers to a chemical moiety with formula —C(O)N(R)₂ or —NHC(O)R, where R is selected from the group consisting of hydrogen, alkyl, cycloalkyl, aryl, heteroaryl (bonded through a ring carbon) and heteroalicyclic (bonded through a ring carbon), each of which moiety may itself be optionally substituted. The R₂ of —N(R)₂ of the amide may optionally be taken together with the nitrogen to which it is attached to form a 4-, 5-, 6- or 7-membered ring. Unless stated otherwise specifically in the specification, an amido group is optionally substituted independently by one or more of the substituents as described herein for alkyl, cycloalkyl, aryl, heteroaryl, or heterocycloalkyl. An amide may be an amino acid or a peptide molecule attached to a compound disclosed herein, thereby forming a prodrug. The procedures and specific groups to make such amides are known to those of skill in the art and can readily be found in seminal sources such as Greene and Wuts, Protective Groups in Organic Synthesis, 3^{rd} Ed., John Wiley & Sons, New York, N.Y., 1999, which is incorporated herein by reference in its entirety.

“Aromatic” or “aryl” or “Ar” refers to an aromatic radical with six to ten ring atoms (e.g., C₆-C₁₀ aromatic or C₆-C₁₀ aryl) which has at least one ring having a conjugated pi electron system which is carbocyclic (e.g., phenyl, fluorenyl, and naphthyl). Bivalent radicals formed from substituted benzene derivatives and having the free valences at ring atoms are named as substituted phenylene radicals. Bivalent radicals derived from univalent polycyclic hydrocarbon radicals whose names end in “-yl” by removal of one hydrogen atom from the carbon atom with the free valence are named by adding “-idene” to the name of the corresponding univalent radical, e.g., a naphthyl group with two points of attachment is termed naphthylidene. Whenever it appears herein, a numerical range such as “6 to 10” refers to each integer in the given range; e.g., “6 to 10 ring atoms” means that the aryl group may consist of 6 ring atoms, 7 ring atoms, etc., up to and including 10 ring atoms. The term includes monocyclic or fused-ring polycyclic (e.g., rings which share adjacent pairs of ring atoms) groups. Unless stated otherwise specifically in the specification, an aryl moiety is optionally substituted by one or more substituents which are independently alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl. It is understood that a substituent R attached to an aromatic ring at an unspecified position,

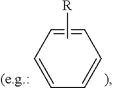

includes one or more, and up to the maximum number of possible substituents.

The term “aryloxy” refers to the group —O-aryl.

The term “substituted aryloxy” refers to aryloxy where the aryl substituent is substituted (e.g., —O-(substituted aryl)). Unless stated otherwise specifically in the specification, the aryl moiety of an aryloxy group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Aralkyl” or “arylalkyl” refers to an (aryl)alkyl-radical where aryl and alkyl are as disclosed herein and which are optionally substituted by one or more of the substituents described as suitable substituents for aryl and alkyl respectively.

“Ester” refers to a chemical radical of formula —COOR, where R is selected from the group consisting of alkyl, cycloalkyl, aryl, heteroaryl (bonded through a ring carbon) and heteroalicyclic (bonded through a ring carbon). The procedures and specific groups to make esters are known to those of skill in the art and can readily be found in seminal sources such as Greene and Wuts, Protective Groups in Organic Synthesis, 3^{rd} Ed., John Wiley & Sons, New York, N.Y., 1999, which is incorporated herein by reference in its entirety. Unless stated otherwise specifically in the specification, an ester group is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, trifluoromethyl, trifluoromethoxy, nitro, trimethylsilanyl, OR^{a}, —SR^{a}, —OC(O)— R¹, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Fluoroalkyl” refers to an alkyl radical, as defined above, that is substituted by one or more fluoro radicals, as defined above, for example, trifluoromethyl, difluoromethyl, 2,2,2-trifluoroethyl, 1-fluoromethyl-2-fluoroethyl, and the like. The alkyl part of the fluoroalkyl radical may be optionally substituted as defined above for an alkyl group.

“Halo,” “halide,” or, alternatively, “halogen” is intended to mean fluoro, chloro, bromo or iodo. The terms “haloalkyl,” “haloalkenyl,” “haloalkynyl,” and “haloalkoxy” include alkyl, alkenyl, alkynyl and alkoxy structures that are substituted with one or more halo groups or with combinations thereof. For example, the terms “fluoroalkyl” and “fluoroalkoxy” include haloalkyl and haloalkoxy groups, respectively, in which the halo is fluorine.

“Heteroalkyl,” “heteroalkenyl,” and “heteroalkynyl” refer to optionally substituted alkyl, alkenyl and alkynyl radicals and which have one or more skeletal chain atoms selected from an atom other than carbon, e.g., oxygen, nitrogen, sulfur, phosphorus or combinations thereof. A numerical range may be given—e.g., C₁-C₄ heteroalkyl which refers to the chain length in total, which in this example is 4 atoms long. A heteroalkyl group may be substituted with one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, nitro, oxo, thioxo, trimethylsilanyl, OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Heteroalkylaryl” refers to an -(heteroalkyl)aryl radical where heteroalkyl and aryl are as disclosed herein and which are optionally substituted by one or more of the substituents described as suitable substituents for heteroalkyl and aryl, respectively.

“Heteroalkylheteroaryl” refers to an -(heteroalkyl)heteroaryl radical where heteroalkyl and heteroaryl are as disclosed herein and which are optionally substituted by one or more of the substituents described as suitable substituents for heteroalkyl and heteroaryl, respectively.

“Heteroalkylheterocycloalkyl” refers to an -(heteroalkyl)heterocycloalkyl radical where heteroalkyl and heterocycloalkyl are as disclosed herein and which are optionally substituted by one or more of the substituents described as suitable substituents for heteroalkyl and heterocycloalkyl, respectively.

“Heteroalkylcycloalkyl” refers to an -(heteroalkyl)cycloalkyl radical where heteroalkyl and cycloalkyl are as disclosed herein and which are optionally substituted by one or more of the substituents described as suitable substituents for heteroalkyl and cycloalkyl, respectively.

“Heteroaryl” or “heteroaromatic” or “HetAr” refers to a 5- to 18-membered aromatic radical (e.g., C₅-C₁₃ heteroaryl) that includes one or more ring heteroatoms selected from nitrogen, oxygen and sulfur, and which may be a monocyclic, bicyclic, tricyclic or tetracyclic ring system. Whenever it appears herein, a numerical range such as “5 to 18” refers to each integer in the given range—e.g., “5 to 18 ring atoms” means that the heteroaryl group may consist of 5 ring atoms, 6 ring atoms, etc., up to and including 18 ring atoms. Bivalent radicals derived from univalent heteroaryl radicals whose names end in “-yl” by removal of one hydrogen atom from the atom with the free valence are named by adding “-idene” to the name of the corresponding univalent radical—e.g., a pyridyl group with two points of attachment is a pyridylidene. A N-containing “heteroaromatic” or “heteroaryl” moiety refers to an aromatic group in which at least one of the skeletal atoms of the ring is a nitrogen atom. The polycyclic heteroaryl group may be fused or non-fused. The heteroatom(s) in the heteroaryl radical are optionally oxidized. One or more nitrogen atoms, if present, are optionally quaternized. The heteroaryl may be attached to the rest of the molecule through any atom of the ring(s). Examples of heteroaryls include, but are not limited to, azepinyl, acridinyl, benzimidazolyl, benzindolyl, 1,3-benzodioxolyl, benzofuranyl, benzooxazolyl, benzo[d]thiazolyl, benzothiadiazolyl, benzo[b][1,4]dioxepinyl, benzo[b][1,4]oxazinyl, 1,4-benzodioxanyl, benzonaphthofuranyl, benzoxazolyl, benzodioxolyl, benzodioxinyl, benzoxazolyl, benzopyranyl, benzopyranonyl, benzofuranyl, benzofuranonyl, benzofurazanyl, benzothiazolyl, benzothienyl(benzothiophenyl), benzothieno[3,2-d]pyrimidinyl, benzotriazolyl, benzo[4,6]imidazo[1,2-a]pyridinyl, carbazolyl, cinnolinyl, cyclopenta[d]pyrimidinyl, 6,7-dihydro-5H-cyclopenta[4,5]thieno[2,3-d]pyrimidinyl, 5,6-dihydrobenzo[h]quinazolinyl, 5,6-dihydrobenzo[h]cinnolinyl, 6,7-dihydro-5H-benzo[6,7]cyclohepta[1,2-c]pyridazinyl, dibenzofuranyl, dibenzothiophenyl, furanyl, furazanyl, furanonyl, furo[3,2-c]pyridinyl, 5,6,7,8,9,10-hexahydrocycloocta[d]pyrimidinyl, 5,6,7,8,9,10-hexahydrocycloocta[d]pyridazinyl, 5,6,7,8,9,10-hexahydrocycloocta[d]pyridinyl, isothiazolyl, imidazolyl, indazolyl, indolyl, indazolyl, isoindolyl, indolinyl, isoindolinyl, isoquinolyl, indolizinyl, isoxazolyl, 5,8-methano-5,6,7,8-tetrahydroquinazolinyl, naphthyridinyl, 1,6-naphthyridinonyl, oxadiazolyl, 2-oxoazepinyl, oxazolyl, oxiranyl, 5,6,6a,7,8,9,10,10a-octahydrobenzo[h]quinazolinyl, 1-phenyl-1H-pyrrolyl, phenazinyl, phenothiazinyl, phenoxazinyl, phthalazinyl, pteridinyl, purinyl, pyranyl, pyrrolyl, pyrazolyl, pyrazolo[3,4-d]pyrimidinyl, pyridinyl, pyrido[3,2-d]pyrimidinyl, pyrido[3,4-d]pyrimidinyl, pyrazinyl, pyrimidinyl, pyridazinyl, pyrrolyl, quinazolinyl, quinoxalinyl, quinolinyl, isoquinolinyl, tetrahydroquinolinyl, 5,6,7,8-tetrahydroquinazolinyl, 5,6,7,8-tetrahydrobenzo[4,5]thieno[2,3-d]pyrimidinyl, 6,7,8,9-tetrahydro-5H-cyclohepta[4,5]thieno[2,3-d]pyrimidinyl, 5,6,7,8-tetrahydropyrido[4,5-c]pyridazinyl, thiazolyl, thiadiazolyl, thiapyranyl, triazolyl, tetrazolyl, triazinyl, thieno[2,3-d]pyrimidinyl, thieno[3,2-d]pyrimidinyl, thieno[2,3-c]pyridinyl, and thiophenyl (e.g., thienyl). Unless stated otherwise specifically in the specification, a heteroaryl moiety is optionally substituted by one or more substituents which are independently: alkyl, heteroalkyl, alkenyl, alkynyl, cycloalkyl, heterocycloalkyl, aryl, arylalkyl, heteroaryl, heteroarylalkyl, hydroxy, halo, cyano, nitro, oxo, thioxo, trimethylsilanyl, OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, —N(R^{a})C(O)N(R^{a})₂, N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

Substituted heteroaryl also includes ring systems substituted with one or more oxide (—O—) substituents, such as, for example, pyridinyl N-oxides.

“Heteroarylalkyl” refers to a moiety having an aryl moiety, as described herein, connected to an alkylene moiety, as described herein, where the connection to the remainder of the molecule is through the alkylene group.

“Heterocycloalkyl” refers to a stable 3- to 18-membered non-aromatic ring radical that comprises two to twelve carbon atoms and from one to six heteroatoms selected from nitrogen, oxygen and sulfur. Whenever it appears herein, a numerical range such as “3 to 18” refers to each integer in the given range—e.g., “3 to 18 ring atoms” means that the heterocycloalkyl group may consist of 3 ring atoms, 4 ring atoms, etc., up to and including 18 ring atoms. Unless stated otherwise specifically in the specification, the heterocycloalkyl radical is a monocyclic, bicyclic, tricyclic or tetracyclic ring system, which may include fused or bridged ring systems. The heteroatoms in the heterocycloalkyl radical may be optionally oxidized. One or more nitrogen atoms, if present, are optionally quaternized. The heterocycloalkyl radical is partially or fully saturated. The heterocycloalkyl may be attached to the rest of the molecule through any atom of the ring(s). Examples of such heterocycloalkyl radicals include, but are not limited to, dioxolanyl, thienyl[1,3]dithianyl, decahydroisoquinolyl, imidazolinyl, imidazolidinyl, isothiazolidinyl, isoxazolidinyl, morpholinyl, octahydroindolyl, octahydroisoindolyl, 2-oxopiperazinyl, 2-oxopiperidinyl, 2-oxopyrrolidinyl, oxazolidinyl, piperidinyl, piperazinyl, 4-piperidonyl, pyrrolidinyl, pyrazolidinyl, quinuclidinyl, thiazolidinyl, tetrahydrofuryl, trithianyl, tetrahydropyranyl, thiomorpholinyl, thiamorpholinyl, 1-oxo-thiomorpholinyl, and 1,1-dioxo-thiomorpholinyl. Unless stated otherwise specifically in the specification, a heterocycloalkyl moiety is optionally substituted by one or more substituents which independently are: alkyl, heteroalkyl, alkenyl, alkynyl, cycloalkyl, heterocycloalkyl, aryl, arylalkyl, heteroaryl, heteroarylalkyl, hydroxy, halo, cyano, nitro, oxo, thioxo, trimethylsilanyl, OR^{a}, —SR^{a}, —OC(O)—R^{a}, —N(R^{a})₂, —C(O)R^{a}, —C(O)OR^{a}, —OC(O)N(R^{a})₂, —C(O)N(R^{a})₂, —N(R^{a})C(O)OR^{a}, —N(R^{a})C(O)R^{a}, N(R^{a})C(O)N(R^{a})₂, N(R^{a})C(NR^{a})N(R^{a})₂, —N(R^{a})S(O)ₜR^{a} (where t is 1 or 2), —S(O)ₜOR^{a} (where t is 1 or 2), —S(O)ₜN(R^{a})₂ (where t is 1 or 2), —S(O)ₜN(R^{a})C(O)R^{a} (where t is 1 or 2), or PO₃(R^{a})₂, where each R^{a} is independently hydrogen, alkyl, fluoroalkyl, carbocyclyl, carbocyclylalkyl, aryl, aralkyl, heterocycloalkyl, heterocycloalkylalkyl, heteroaryl or heteroarylalkyl.

“Heterocycloalkyl” also includes bicyclic ring systems where one non-aromatic ring, usually with 3 to 7 ring atoms, contains at least 2 carbon atoms in addition to 1-3 heteroatoms independently selected from oxygen, sulfur, and nitrogen, as well as combinations including at least one of the foregoing heteroatoms; and the other ring, usually with 3 to 7 ring atoms, optionally contains 1-3 heteroatoms independently selected from oxygen, sulfur, and nitrogen and is not aromatic.

“Nitro” refers to the —NO₂ radical.

“Oxa” refers to the —O— radical.

“Oxo” refers to the ═O radical.

“Isomers” are different compounds that have the same molecular formula. “Stereoisomers” are isomers that differ only in the way the atoms are arranged in space—e.g., having a different stereochemical configuration. “Enantiomers” are a pair of stereoisomers that are non-superimposable mirror images of each other. A 1:1 mixture of a pair of enantiomers is a “racemic” mixture. The term “(±)” is used to designate a racemic mixture where appropriate. “Diastereoisomers” are stereoisomers that have at least two asymmetric atoms, but which are not mirror-images of each other. The absolute stereochemistry is specified according to the Cahn-Ingold-Prelog R—S system. When a compound is a pure enantiomer the stereochemistry at each chiral carbon can be specified by either (R) or (S). Resolved compounds whose absolute configuration is unknown can be designated (+) or (—) depending on the direction (dextro- or levorotatory) which they rotate plane polarized light at the wavelength of the sodium D line. Certain of the compounds described herein contain one or more asymmetric centers and can thus give rise to enantiomers, diastereomers, and other stereoisomeric forms that can be defined, in terms of absolute stereochemistry, as (R) or (S). The present chemical entities, compositions and methods are meant to include all such possible isomers, including racemic mixtures, optically pure forms and intermediate mixtures. Optically active (R)- and (S)-isomers can be prepared using chiral synthons or chiral reagents, or resolved using conventional techniques. When the compounds described herein contain olefinic double bonds or other centers of geometric asymmetry, and unless specified otherwise, it is intended that the compounds include both E and Z geometric isomers.

In some embodiments, enantiomerically enriched compositions have different properties than the racemic mixture of that composition. Enantiomers can be isolated from mixtures by methods known to those skilled in the art, including chiral high pressure liquid chromatography (HPLC) and the formation and crystallization of chiral salts; or preferred enantiomers can be prepared by asymmetric syntheses. See, for example, Jacques, et al., Enantiomers, Racemates and Resolutions, Wiley Interscience, New York (1981); E. L. Eliel, Stereochemistry of Carbon Compounds, McGraw-Hill, New York (1962); and E. L. Eliel and S. H. Wilen, Stereochemistry of Organic Compounds, Wiley-Interscience, New York (1994).

The terms “enantiomerically enriched” and “non-racemic,” as used herein, refer to compositions in which the percent by weight of one enantiomer is greater than the amount of that one enantiomer in a control mixture of the racemic composition (e.g., greater than 1:1 by weight). For example, an enantiomerically enriched preparation of the (S)-enantiomer, means a preparation of the compound having greater than 50% by weight of the (S)-enantiomer relative to the (R)-enantiomer, such as at least 75% by weight, or such as at least 80% by weight. In some embodiments, the enrichment can be significantly greater than 80% by weight, providing a “substantially enantiomerically enriched” or a “substantially non-racemic” preparation, which refers to preparations of compositions which have at least 85% by weight of one enantiomer relative to other enantiomer, such as at least 90% by weight, or such as at least 95% by weight. The terms “enantiomerically pure” or “substantially enantiomerically pure” refers to a composition that comprises at least 98% of a single enantiomer and less than 2% of the opposite enantiomer.

“Moiety” refers to a specific segment or functional group of a molecule. Chemical moieties are often recognized chemical entities embedded in or appended to a molecule.

“Tautomers” are structurally distinct isomers that interconvert by tautomerization. “Tautomerization” is a form of isomerization and includes prototropic or proton-shift tautomerization, which is considered a subset of acid-base chemistry. “Prototropic tautomerization” or “proton-shift tautomerization” involves the migration of a proton accompanied by changes in bond order, often the interchange of a single bond with an adjacent double bond. Where tautomerization is possible (e.g., in solution), a chemical equilibrium of tautomers can be reached. An example of tautomerization is keto-enol tautomerization. A specific example of keto-enol tautomerization is the interconversion of pentane-2,4-dione and 4-hydroxypent-3-en-2-one tautomers. Another example of tautomerization is phenol-keto tautomerization. A specific example of phenol-keto tautomerization is the interconversion of pyridin-4-ol and pyridin-4(1H)-one tautomers.

A “leaving group or atom” is any group or atom that will, under selected reaction conditions, cleave from the starting material, thus promoting reaction at a specified site. Examples of such groups, unless otherwise specified, include halogen atoms and mesyloxy, p-nitrobenzensulphonyloxy and tosyloxy groups.

“Protecting group” is intended to mean a group that selectively blocks one or more reactive sites in a multifunctional compound such that a chemical reaction can be carried out selectively on another unprotected reactive site and the group can then be readily removed or deprotected after the selective reaction is complete. A variety of protecting groups are disclosed, for example, in Greene and Wuts, 1999, Protective Groups in Organic Synthesis, Third Edition, John Wiley & Sons, New York.

“Solvate” refers to a compound in physical association with one or more molecules of a pharmaceutically acceptable solvent.

“Substituted” means that the referenced group may have attached one or more additional groups, radicals or moieties individually and independently selected from, for example, acyl, alkyl, alkylaryl, cycloalkyl, aralkyl, aryl, carbohydrate, carbonate, heteroaryl, heterocycloalkyl, hydroxy, alkoxy, aryloxy, mercapto, alkylthio, arylthio, cyano, halo, carbonyl, ester, thiocarbonyl, isocyanato, thiocyanato, isothiocyanato, nitro, oxo, perhaloalkyl, perfluoroalkyl, phosphate, silyl, sulfinyl, sulfonyl, sulfonamidyl, sulfoxyl, sulfonate, urea, and amino, including mono- and di-substituted amino groups, and protected derivatives thereof. The substituents themselves may be substituted, for example, a cycloalkyl substituent may itself have a halide substituent at one or more of its ring carbons. The term “optionally substituted” means optional substitution with the specified groups, radicals or moieties.

“Sulfanyl” refers to groups that include —S-(optionally substituted alkyl), —S-(optionally substituted aryl), —S-(optionally substituted heteroaryl) and —S-(optionally substituted heterocycloalkyl).

“Sulfinyl” refers to groups that include —S(O)—H, —S(O)-(optionally substituted alkyl), —S(O)-(optionally substituted amino), —S(O)-(optionally substituted aryl), —S(O)-(optionally substituted heteroaryl) and —S(O)-(optionally substituted heterocycloalkyl).

“Sulfonyl” refers to groups that include —S(O₂)—H, —S(O₂)-(optionally substituted alkyl), —S(O₂)-(optionally substituted amino), —S(O₂)-(optionally substituted aryl), —S(O₂)-(optionally substituted heteroaryl), and —S(O₂)-(optionally substituted heterocycloalkyl).

“Sulfonamidyl” or “sulfonamido” refers to a —S(═O)₂—NRR radical, where each R is selected independently from the group consisting of hydrogen, alkyl, cycloalkyl, aryl, heteroaryl (bonded through a ring carbon) and heteroalicyclic (bonded through a ring carbon). The R groups in —NRR of the —S(═O)₂—NRR radical may be taken together with the nitrogen to which it is attached to form a 4-, 5-, 6- or 7-membered ring. A sulfonamido group is optionally substituted by one or more of the substituents described for alkyl, cycloalkyl, aryl, heteroaryl, respectively.

“Sulfoxyl” refers to a —S(═O)₂OH radical.

“Sulfonate” refers to a —S(═O)₂—OR radical, where R is selected from the group consisting of alkyl, cycloalkyl, aryl, heteroaryl (bonded through a ring carbon) and heteroalicyclic (bonded through a ring carbon). A sulfonate group is optionally substituted on R by one or more of the substituents described for alkyl, cycloalkyl, aryl, heteroaryl, respectively.

Compounds of the present disclosure also include crystalline and amorphous forms of those compounds, including, for example, polymorphs, pseudopolymorphs, solvates, hydrates, unsolvated polymorphs (including anhydrates), conformational polymorphs, and amorphous forms of the compounds, as well as mixtures thereof. “Crystalline form” and “polymorph” are intended to include all crystalline and amorphous forms of the compound, including, for example, polymorphs, pseudopolymorphs, solvates, hydrates, unsolvated polymorphs (including anhydrates), conformational polymorphs, and amorphous forms, as well as mixtures thereof, unless a particular crystalline or amorphous form is referred to.

For the avoidance of doubt, it is intended herein that particular features (for example integers, characteristics, values, uses, formulae, compounds or groups) described in conjunction with a particular aspect, embodiment or example of the disclosure are to be understood as applicable to any other aspect, embodiment or example described herein unless incompatible therewith. Thus, such features may be used where appropriate in conjunction with any of the definition, claims or embodiments defined herein. All of the features disclosed in this specification (including any accompanying claims, abstract and drawings), and/or all of the steps of any method or process so disclosed, may be combined in any combination, except combinations where at least some of the features and/or steps are mutually exclusive. The present disclosure is not restricted to any details of any disclosed embodiments. The present disclosure extends to any novel one, or novel combination, of the features disclosed in this specification (including any accompanying claims, abstract and drawings), or to any novel one, or any novel combination, of the steps of any method or process so disclosed.

### III. Compositions

One aspect of the present disclosure provides a polymer that has, or is derived by side-chain crosslinking from, the structure:

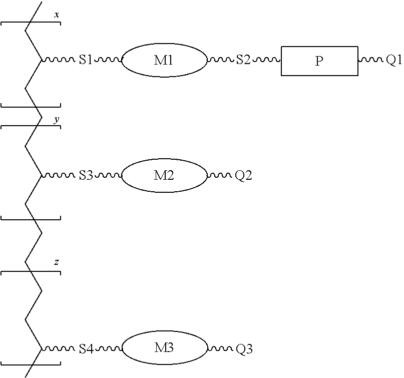

where P is an ultraviolet photoreactive moiety, M1 is a calamitic mesogenic or non-mesogenic moiety, M2 is a calamitic mesogenic moiety, M3 is a calamitic mesogenic or non-mesogenic moiety, at least two of Q1, Q2, and Q3 are each photo-curable moiety or at least two of Q1, Q2, and Q3 are each a thermal-curable moiety, and S1, S2, S3, and S4 are spacers. In some embodiments, x+y=1 and z is equal to zero.

In some embodiments x+y+z=1. In some such embodiments, R1 is non-curable so that P can be liberated to focus on the alignment function, and M3 is for crystallization control and reaction with R2.

In some embodiments, P is:

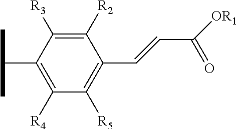

where R₁, R₂, R₃, R₄, and R₅ are each independently hydrogen, halogen, cyano, amino, substituted amino, nitro, substituted or unsubstituted n-alkyl, substituted or unsubstituted branched-chain alkyl, substituted or unsubstituted hetroalkyl, or substituted or unsubstituted branched-chain hetroalkyl. In some such embodiments, R₂, R₃, R₄ and R₅ are each hydrogen.

In some embodiments P is:

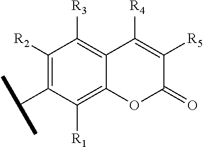

where R₁, R₂, R₃, R₄, R₅, and R₆ are each independently hydrogen, halogen, cyano, amino, substituted amino, nitro, substituted or unsubstituted n-alkyl, substituted or unsubstituted branched-chain alkyl, substituted or unsubstituted hetroalkyl, or substituted or unsubstituted branched-chain hetroalkyl. In some such embodiments, R₁, R₂, R₃, R₄, and R₅ are each hydrogen.

In some embodiments, P is:

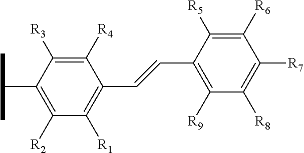

where R₁, R₂, R₃, R₄, R₅, R₆, R₇, R₈, and R₉ are each independently hydrogen, halogen, cyano, amino, substituted amino, nitro, substituted or unsubstituted n-alkyl, substituted or unsubstituted branched-chain alkyl, substituted or unsubstituted hetroalkyl, or substituted or unsubstituted branched-chain hetroalkyl. In some such embodiments, R₁, R₂, R₃, R₄, R₅, R₆, R₇, R₈, and R₉ are each hydrogen.

In some embodiments Q2 and Q3 are each photo-curable. For instance, in some embodiments Q2 and Q3 are the same and are selected from the group consisting of:

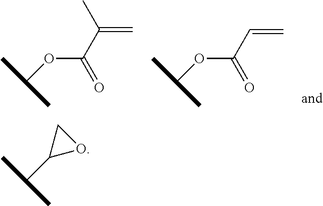

In some embodiments Q2 and Q3 are each a free-radical polymerization agent, such as an acrylate, methacrylate, cyanoacrylate, or styrene. See, for example, Matyjaszewski, 1998, “Atom Transfer Radical Polymerization and the Synthesis of Polymeric Materials,” Adv. Mater. 10(12), pp. 901-915.

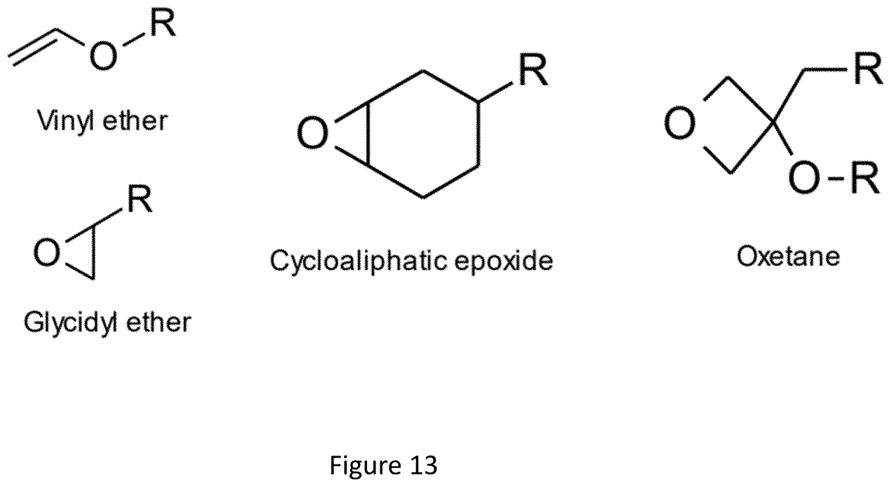

In some embodiments, Q2 and Q3 are each a cationic polymerizable group. For example, in some embodiments Q2 and Q3 are each a cationic polymerizable group containing a vinylether, a glycidyl etheran epoxide (e.g., a cycloaliphatic epoxide), a thiirane, or an oxetane. For instance, in some embodiments, Q2 and Q3 are each a cationic polymerizable group disclosed in FIG. 13, in which each R is independently hydrogen, halogen, cyano, amino, substituted amino, nitro, substituted or unsubstituted n-alkyl, substituted or unsubstituted branched-chain alkyl, substituted or unsubstituted hetroalkyl, or substituted or unsubstituted branched-chain hetroalkyl. Additional example description of suitable cationic polymerizable groups for Q2 and Q3, such as vinylethers, epoxides, thiiranes, and oxetanes, is disclosed in Lazauskaite and Grazulevicius, 2005, “Synthesis and cationic photopolymerization of electroactive monomers containing functional groups,” Polymers for Advanced Techonologies 16: 571-581, which is hereby incorporated by reference. In some embodiments Q2 and Q3 are each a photoacid generator such as the one illustrated to the right above. In some embodiments Q2 and Q3 are each cyclic monomers that polymerize through cationic ring-opening polymerization (CROP). Examples of cyclic monomers that polymerize through this mechanism include lactones, lactams, cyclic amines, and cyclic ethers. See, for example, Cowie, John McKenzie Grant, 2008, Polymers: Chemistry and Physics of Modern Materials, Boca Raton, Fla.: CRC Press. pp. 105-107, which is hereby incorporated by reference. CROP proceeds through an S_{N}1 or S_{N}2 propagation, chain-growth process. See, for example, Nuyken et al., 2013, “Ring-Opening Polymerization—An Introductory Review,” Polymers. 5(2), pp. 361-403. The mechanism is affected by the stability of the resulting cationic species. For example, if the atom bearing the positive charge is stabilized by electron-donating groups, polymerization will proceed by the SN1 mechanism. See, Dubois, 2008, Handbook of ring-opening polymerization (1. Aufl. ed.). Weinheim: Wiley-VCH. The cationic species is a heteroatom and the chain grows by the addition of cyclic monomers thereby opening the ring system. The monomers can be activated by Bronsted acids, carbenium ions, onium ions, and metal cations. See, for example, Nuyken et al., 2013, “Ring-Opening Polymerization—An Introductory Review,” Polymers. 5(2), pp. 361-403.

In some embodiments Q2 and Q3 are each thermal-curable. In some such embodiments Q2 is a protected or unprotected —N═C—O and Q3 is a —R₁-hydroxyl, wherein R₁ is an unsubstituted n-alkyl.

In some embodiments M1, M2, or M3 has the structure:

Q₁-A-Y-B-Q₂

where A and B are each independently substituted or unsubstituted 1,4-phenyl, 2,5-pyridinyl, 2-6-naphthyl, trans-1-,4-cyclohexyl, 4,4′-biphenyl, 1,4-bicyclo[2.2.2]octyl, trans-1,3-cyclobutyl, trans-2-5-dioxanyl, trans-2,6-decalinyl, or one of:

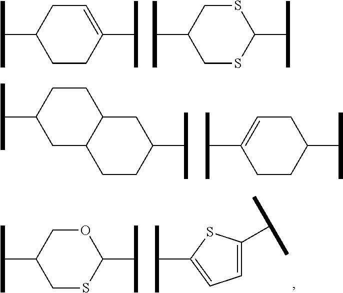

Y is either a direct covalent bond between A and B, —CH═N—, —N═N—, —CO₂—, —C≡C—, —CH₂CH₂—, —(C═O)—O—, —CH═CH—(C═O)—O—, —(CH₂)—O—, —CH═CH—, or

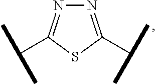

and Q₁ and Q₂ are each independently an unsubstituted n-alkyl, a substituted or unsubstituted branched-chain alkyl, a substituted or unsubstituted alkoxy, a substituted or unsubstituted sulfanyl, a substituted or unsubstituted alkoxycarbonyl, —CN, —F, —NCS, —(CO)OH, or —NO₂.

In some embodiments M1, M2, or M3 has the structure:

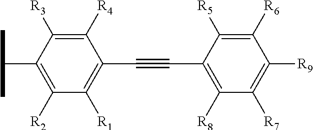

where R₁, R₂, R₃, R₄, R₅, R₆, R₇, and R₈, are each independently hydrogen, halogen, cyano, amino, substituted amino, nitro, substituted or unsubstituted n-alkyl, substituted or unsubstituted branched-chain alkyl, substituted or unsubstituted hetroalkyl, or substituted or unsubstituted branched-chain hetroalkyl and R₉ is an unsubstituted alkoxycarbonyl. In some such embodiments, A and B are each unsubstituted 1,4-phenyl.

In some embodiments M1, M2, or M3 has the structure:

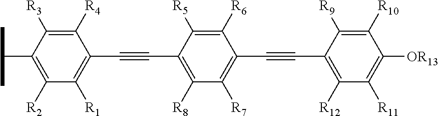

where R₁, R₂, R₃, R₄, R₅, R₆, R₇, R₈, R₉, R₁₀, R₁₁, R₁₂, and R₁₃ are each independently hydrogen, halogen, cyano, amino, substituted amino, nitro, substituted or unsubstituted n-alkyl, substituted or unsubstituted branched-chain alkyl, substituted or unsubstituted hetroalkyl, or substituted or unsubstituted branched-chain hetroalkyl. In some such embodiments, R₁, R₂, R₃, R₄, R₅, R₇, R₉, R₁₀, R₁₁, R₁₂, and R₁₃ are each hydrogen and R₆ and R₈ are each methyl.

In some embodiments M1, M2, or M3 has the structure:

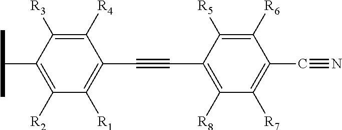

where R₁, R₂, R₃, R₄, R₅, R₆, R₇, and R₈ are each independently hydrogen, halogen, cyano, amino, substituted amino, nitro, substituted or unsubstituted n-alkyl, substituted or unsubstituted branched-chain alkyl, substituted or unsubstituted hetroalkyl, or substituted or unsubstituted branched-chain hetroalkyl. In some such embodiments, A and B are each unsubstituted 1,4-phenyl.

In some embodiments, M1, M2, or M3 has the structure:

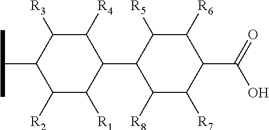

where R₁, R₂, R₃, R₄, R₅, R₆, R₇, and R₈ are each independently hydrogen, halogen, cyano, amino, substituted amino, nitro, substituted or unsubstituted n-alkyl, substituted or unsubstituted branched-chain alkyl, substituted or unsubstituted hetroalkyl, or substituted or unsubstituted branched-chain hetroalkyl. In some such embodiments, R₁, R₂, R₃, R₄, R₅, R₆, R₇, and R₈ are each hydrogen.

In some embodiments, x+y+z=1, and the polymer has the structure:

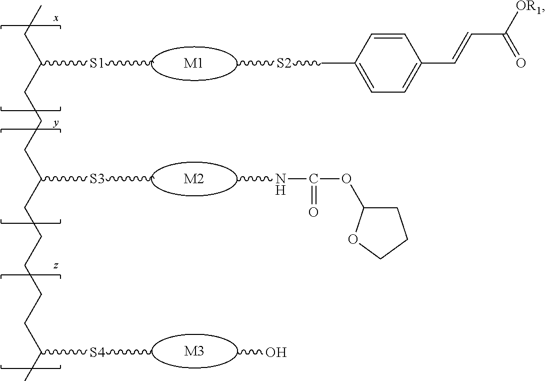

where R₁ is Hydrogen, a substituted n-alkyl, or an unsubstituted n-alkyl.

In some embodiments, x+y=1 and z is equal to zero, and the polymer has the structure:

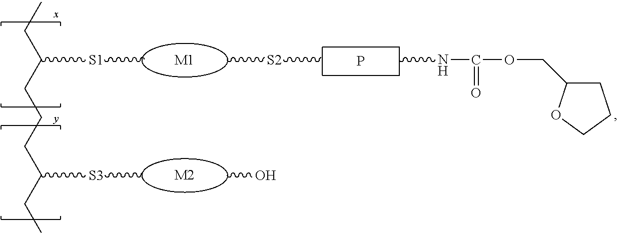

In some embodiments x+y=1 and z is equal to zero, and the polymer has the structure:

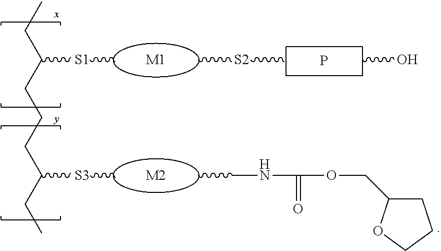

In some embodiments, x=1, y=0, and z−0, and the polymer has the structure:

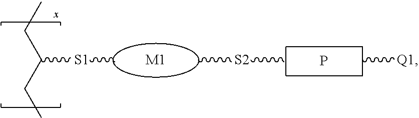

where Q1 is ultraviolet photo-curable.

In some embodiments, S1, S3, or S4 has the structure —(CO)—(CH₂)ₙ—O—, where n is between 2 and 20.

In some embodiments, S1, S2, S3, or S4 has the structure —(CH₂)ₙ—, where n is between 2 and 20.

In some embodiments, S1, S2, S3, or S4 is each independently a substituted or unsubstituted n-alkyl, a substituted or unsubstituted hetroalkyl, a substituted or unsubstituted alkoxy, or a substituted or unsubstituted alkoxycarbonyl.

In some embodiments, the polymer is optically clear.

In some embodiments, M1, M2, or M3 has a birefringence between 0.04 and 0.40.

In some embodiments Q1 and Q2 are each a photo-curable moiety. In some such embodiments, Q1 and Q2 form inter-strand crosslinks with each other upon exposure to a light source, such as for example ultraviolet radiation. In some embodiments, Q1 and Q2 form inter-strand crosslinks with each other upon exposure to a light source within a particular wavelength range in the visible or ultraviolet radiation spectrums. In some such embodiments, Q3 is a photo-curable moiety or a thermal-curable moiety.

In some embodiments Q2 and Q3 are each a photo-curable moiety. In some such embodiments, Q2 and Q3 form inter-strand crosslinks with each other upon exposure to a light source, such as for example ultraviolet radiation. In some embodiments, Q2 and Q3 form inter-strand crosslinks with each other upon exposure to a light source within a particular wavelength range in the visible or ultraviolet radiation spectrums. In some such embodiments, Q1 is a photo-curable moiety or a thermal-curable moiety.

In some embodiments Q1 and Q3 are each a photo-curable moiety. In some such embodiments, Q1 and Q3 form inter-strand crosslinks with each other upon exposure to a light source, such as for example ultraviolet radiation. In some embodiments, Q1 and Q3 form inter-strand crosslinks with each other upon exposure to a light source within a particular wavelength range in the visible or ultraviolet radiation spectrums. In some such embodiments, Q2 is a photo-curable moiety or a thermal-curable moiety.

In some embodiments Q1 and Q2 are each a thermal-curable moiety. In some such embodiments, Q1 and Q2 form inter-strand crosslinks with each other upon thermal curing. In some such embodiments, Q3 is a photo-curable moiety or a thermal-curable moiety.

In some embodiments Q2 and Q3 are each a photo-curable moiety. In some such embodiments, Q2 and Q3 form inter-strand crosslinks with each other upon thermal curing. In some such embodiments, Q1 is a photo-curable moiety or a thermal-curable moiety.

In some embodiments Q1 and Q3 are each a photo-curable moiety. In some such embodiments, Q1 and Q3 form inter-strand crosslinks with each other upon thermal curing. In some such embodiments, Q2 is a photo-curable moiety or a thermal-curable moiety.

### IV. Synthetic Methods

One aspect of the present disclosure provides a method of forming a polarization volume hologram using any of the polymers disclosed in Section III.

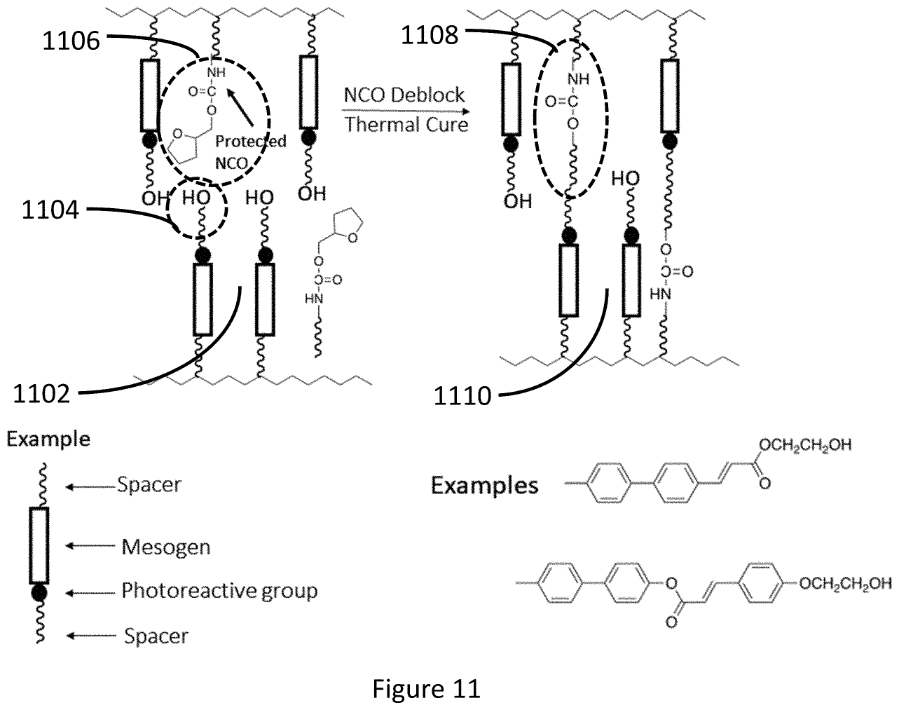

In some embodiments where a polymer disclosed in Section III has Q1 and Q2 that are thermal-curable and Q3 that is either not present or is photo-curable, to form a polarization volume hologram, the polymer is subjected to an elevated temperature causing some of the thermal-curable moieties Q1/Q2 to react with each other. For example, as depicted in FIG. 11, upon —N═C═O deblock and thermal exposure of the polymer, Q1 1104 (of the form —R₁— hydroxyl) and Q2 1106 (now in the form of unprotected —N═C—O) in illustration 1102 react with each other to form cross-link 1108 in illustration 1110. In some embodiments, subsequent thermal annealing in liquid crystal phase aligns all the mesogenic groups in the polymer in accordance with the cross-links in illustration 1110 of FIG. 11. Referring to FIG. 11, the polymer is further stabilized in some embodiments with a post ultraviolet cure in which inter-strand photoreactive groups crosslink with each other.

In some embodiments where a polymer disclosed in Section III has Q1 and Q2 that are photo-curable and Q3 that is either not present or is photo-curable, to form a polarization volume hologram, the polymer is subjected to initial UV light causing some of the photo-curable moieties Q1/Q2 to react with each other. For some select P, a small anisotropy can be induced in the polymer that is amplified upon thermal annealing in liquid crystal phase to align all the mesogenic groups in the polymer in accordance with the initial Q1/Q2 inter-strand cross-links. In some embodiments the polymer is further stabilized with a post ultraviolet cure in which inter-strand photoreactive groups crosslink with each other as illustrated in FIG. 11.

In some embodiments, Q1, Q2 and/or Q3 is methacrylate and the methyacrylate monomer is synthesized in accordance with general synthetic schemes disclosed in Kawatsuki et al., 2002, Macromolecules 35, pp. 706-713, which is hereby incorporated by reference. In some embodiments the monomers of section III are synthesized in accordance with the general synthetic schemes disclosed in Kawatsuki et al., 2006, “Photoinduced Reorientation and Multiple Optical Data Storage in Photo-Cross-Linkable Liquid Crystalline Copolymer Films Using 405 nm Light,” Macromolecules 39, pp. 3245-3251, which is hereby incorporated by reference.

In some embodiments, the polarization volume hologram has a Δn of less than 0.1. In some embodiments, the polarization volume hologram has a Δn between 0.1 and 0.4. In some embodiments the polymer in the polarization volume hologram has a thickness of between 0.1 μm and 0.5 μm. In some embodiments the polymer in the polarization volume hologram has a thickness of between 0.05 μm and 2.5 μm.

### V. CONCLUSION

While preferred embodiments are shown and described herein, such embodiments are provided by way of example only and are not intended to otherwise limit the scope of the disclosure. Various alternatives to the described embodiments may be employed in practicing the disclosure.

A number of patent and non-patent publications are cited herein in order to describe the state of the art to which this disclosure pertains. The entire disclosure of each of these publications is incorporated by reference herein.

While certain embodiments are described and/or exemplified herein, various other embodiments will be apparent to those skilled in the art from the disclosure. The present disclosure is, therefore, not limited to the particular embodiments described and/or exemplified, but is capable of considerable variation and modification without departure from the scope and spirit of the appended claims.

1. A polymer having the structure: 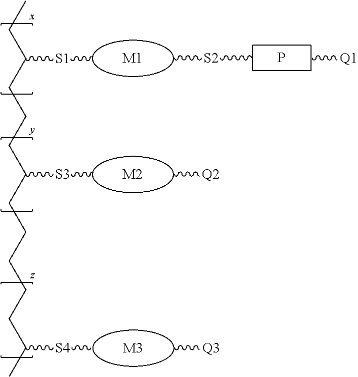
wherein:
P is an ultraviolet photoreactive moiety,
M1 is a calamitic mesogenic or non-mesogenic moiety,
M2 is a calamitic mesogenic moiety,
M3 is a calamitic mesogenic or non-mesogenic moiety,
at least two of Q1, Q2, and Q3 are each photo-curable moiety or at least two of Q1, Q2, and Q3 are each a thermal-curable moiety, and
S1, S2, S3, and S4 are spacers, and wherein:
(i) x+y=1 and z is equal to zero, or
(ii) x+y+z=1.

2. The polymer of claim 1, wherein P is: 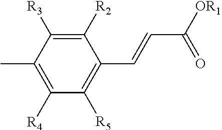
wherein R₁, R₂, R₃, R₄, and R₅ are each independently hydrogen, halogen, cyano, amino, substituted amino, nitro, substituted or unsubstituted n-alkyl, substituted or unsubstituted branched-chain alkyl, substituted or unsubstituted hetroalkyl, or substituted or unsubstituted branched-chain hetroalkyl.

3. (canceled)

4. The polymer of claim 1, wherein P is: 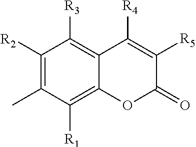
wherein R₁, R₂, R₃, R₄, R₅, and R₆ are each independently hydrogen, halogen, cyano, amino, substituted amino, nitro, substituted or unsubstituted n-alkyl, substituted or unsubstituted branched-chain alkyl, substituted or unsubstituted hetroalkyl, or substituted or unsubstituted branched-chain hetroalkyl.

5. (canceled)

6. The polymer of claim 1, wherein P is: 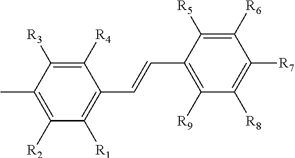
wherein R₁, R₂, R₃, R₄, R₅, R₆, R₇, R₈, and R₉ are each independently hydrogen, halogen, cyano, amino, substituted amino, nitro, substituted or unsubstituted n-alkyl, substituted or unsubstituted branched-chain alkyl, substituted or unsubstituted hetroalkyl, or substituted or unsubstituted branched-chain hetroalkyl.

7. (canceled)

8. The polymer of claim 1, wherein Q2 and Q3 are each photo-curable.

9. The polymer of claim 8, wherein Q2 and Q3 are the same and are selected from the group consisting of:

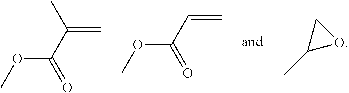

10. The polymer of claim 1, wherein Q2 and Q3 are each thermal-curable.

11. The polymer of claim 10, wherein Q2 is a protected or unprotected —N═C—O and Q3 is an —R₁-hydroxyl, wherein R₁ is an unsubstituted n-alkyl.

12. The polymer of claim 1, wherein M1, M2, or M3 has the structure:
Q₁-A-Y-B-Q₂
wherein,
A and B are each independently substituted or unsubstituted 1,4-phenyl, 2,5-pyridinyl, 2-6-naphthyl, trans-1-,4-cyclohexyl, 4,4′-biphenyl, 1,4-bicyclo[2.2.2]octyl, trans-1,3-cyclobutyl, trans-2-5-dioxanyl, trans-2,6-decalinyl, or one of 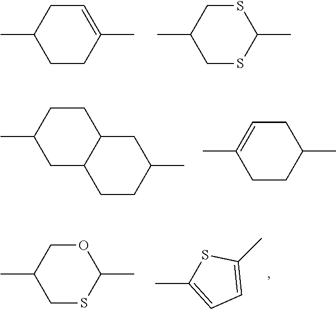
Y is either a direct covalent bond between A and B, —CH═N—, —N═N—, —CO₂—, —C≡C—, —CH₂CH₂—, —(C═O)—O—, —CH═CH—(C═O)—O—, —(CH₂)—O—, —CH═CH—, or 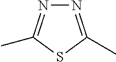
and Q₁ and Q₂ are each independently an unsubstituted n-alkyl, a substituted or unsubstituted branched-chain alkyl, a substituted or unsubstituted alkoxy, a substituted or unsubstituted sulfanyl, a substituted or unsubstituted alkoxycarbonyl, —CN, —F, —NCS, —(CO)OH, or —NO₂.

13. The polymer of claim 12, wherein M1, M2, or M3 has the structure: 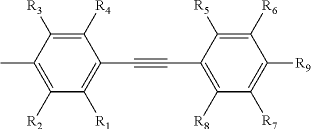
wherein R₁, R₂, R₃, R₄, R₅, R₆, R₇, and R₈ are each independently hydrogen, halogen, cyano, amino, substituted amino, nitro, substituted or unsubstituted n-alkyl, substituted or unsubstituted branched-chain alkyl, substituted or unsubstituted hetroalkyl, or substituted or unsubstituted branched-chain hetroalkyl and R₉ is an unsubstituted alkoxycarbonyl.

14. The polymer of claim 13, wherein A and B are each unsubstituted 1,4-phenyl.

15. The polymer of claim 1, wherein M1, M2, or M3 has the structure: 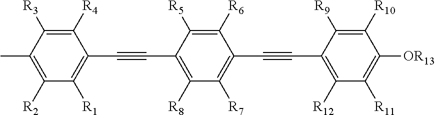
wherein R₁, R₂, R₃, R₄, R₅, R₆, R₇, R₈, R₉, R₁₀, R₁₁, R₁₂, and R₁₃ are each independently hydrogen, halogen, cyano, amino, substituted amino, nitro, substituted or unsubstituted n-alkyl, substituted or unsubstituted branched-chain alkyl, substituted or unsubstituted hetroalkyl, or substituted or unsubstituted branched-chain hetroalkyl.

16. The polymer of claim 15, wherein R₁, R₂, R₃, R₄, R₅, R₇, R₉, R₁₀, R₁₁, R₁₂, and R₁₃ are each hydrogen and R₆ and R₈ are each methyl.

17. The polymer of claim 12, wherein M1, M2, or M3 has the structure: 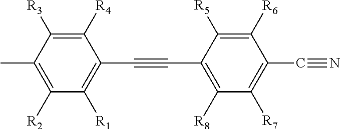
wherein R₁, R₂, R₃, R₄, R₅, R₆, R₇, and R₈ are each independently hydrogen, halogen, cyano, amino, substituted amino, nitro, substituted or unsubstituted n-alkyl, substituted or unsubstituted branched-chain alkyl, substituted or unsubstituted hetroalkyl, or substituted or unsubstituted branched-chain hetroalkyl.

18. (canceled)

19. The polymer of claim 12, wherein M1, M2, or M3 has the structure: 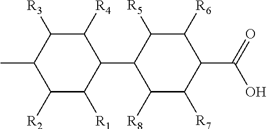
wherein R₁, R₂, R₃, R₄, R₅, R₆, R₇, and R₈ are each independently hydrogen, halogen, cyano, amino, substituted amino, nitro, substituted or unsubstituted n-alkyl, substituted or unsubstituted branched-chain alkyl, substituted or unsubstituted hetroalkyl, or substituted or unsubstituted branched-chain hetroalkyl.

20. (canceled)

21. The polymer of claim 1, wherein x+y+z=1, having the structure: 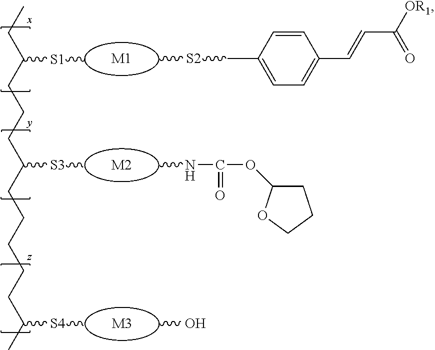
wherein R₁ is Hydrogen, a substituted n-alkyl, or an unsubstituted n-alkyl.

22. The polymer of claim 1, wherein x+y=1 and z is equal to zero, having the structure:

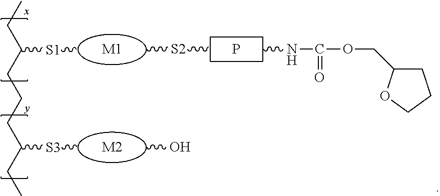

23. The polymer of claim 1, wherein x+y=1 and z is equal to zero, having the structure:

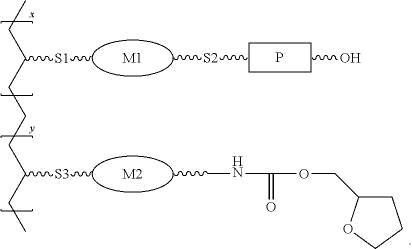

24. The polymer of claim 1, wherein x=1, y=0, and z−0, having the structure: 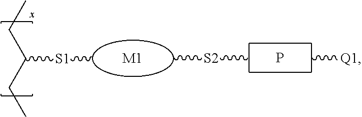
wherein Q1 is ultraviolet photo-curable.

25. The polymer of claim 1, wherein S1, S3, or S4 has the structure —(CO)—(CH₂)ₙ—O—, wherein n is between 2 and 20.

26-34. (canceled)
